(19) United States
(12) Patent Application Publication
(10) Pub. No.: US 2007/0235971 A1
(43) Pub. Date: Oct. 11, 2007

(54) Integrating axle for scooters

(76) Inventors: Winn L. Woods, Tempe, AZ (US); Endea D. Woods, Tempe, AZ (US)

Correspondence Address: Winn L. Woods, P O BOX 2678, Tempe, AZ, 85280, US

(21) Appl. No.: 11/398,914

(22) Filed: Apr. 6, 2006

(51) Int. Cl. B62M 1/00

(52) U.S. Cl. 280/87.041

(57) ABSTRACT

An “Integrating Axle” for scooters that feature attributes sufficient to result in a stable free standing utility vehicle. Where the “Integrating Axle” is adaptable as embodied in a bolt on steering, suspension and axle shaft arrangement structurally rendered to affix a utility carriage to a two-wheel board style ride scooter in a forward of standing rider position set on four ground contacting members situated in a diamond stance to the longitudinal axis. An adaptive device configured to increase the wheel diameters of the primary forward support ground contacting members to a diameter of 53.34 centimeters/21 inches. A device where force, fulcrum and load are displaced to minimize jarring and other surface impacts. A utility with improved safety quotients that affirmatively expands usage of two wheel board scooter.

### BACKGROUND OF INVENTION

1. Field of the Invention

Two wheeled standing scooters as common and known. An example of such a scooter can be found in the patent literature in Patmont U.S. Pat. No. 4,821,832 issued Apr. 18, 1989 entitled Motor Scooter Having a foldable Handle and Friction Drive. The exiting field utilizes wheel diameters ranging between 10.16 centimeter 4.0 inch and 25.4 centimeter/10.0 inch. At present, two wheeled standing scooters are equipped with fork-type or cantilever type systems that are supported by a journal leading to a rotating steering column.

2. Background Art

Existing two-wheel board style ride scooters utilize the fork-neck-yoke device to effect steering. The existing state of the art is confined to a small diameter primary wheel. Road conditions that include pot holes, rocks and debris have resulted in loss of control for even the most experienced riders. Here a solution where an increase in wheel diameter raises the center or tangent of the primary wheel to traverse harsher surface conditions. The Integrating Axle for Scooters is situated so as to permit a bolt on solution which results in a free standing vehicle platform. Existing two-wheel board style ride scooters do not offer utility carriage. Some existing two-wheel board style ride scooters offer rear pull trailers for towing. Rear affixed trailers are difficult to manage on uneven grades at decline. The Invention permits the utility carriage to be situated forward of the operator for greater control on declined and inclined surfaces. The Invention permits bolt on utility carriage adaptation.

### BRIEF SUMMARY OF INVENTION

A device where fulcrum-lever assist dynamics are inherent in arrangement.

A device that introduces the useful dynamics of a fulcrum to two-wheel board style ride scooters to produce a desirable effect for rider standing on platform while managing forward baring loads through an offset fulcrum lever arrangement.

A device that permits the consolidation of a two-wheel board style ride scooter, and a utility carriage where the joining of the two results in a single operator utility vehicle supported by four ground contacting members of independent travel.

An integrating device that facilitates an arrangement whereby a two-wheeled board style ride scooter can be safely and securely attached to a forward positioned utility carriage. A device that provides advantageous mounting points for a synergized expression of the rider, steering, suspension and stability set in easy to bolt on and setup adaptation.

An invention that facilitates an arrangement of ground contacting members in a diamond shaped pattern vertical to the longitudinal plane to enhance vehicle stability throughout steering control radius.

A device where the offset connecting points creates a slightly negative steering dynamic that assist in steering and control in adverse surface conditions such as rough or uniformed terrains

A device that incorporates a suitable axle shaft to accommodate bearings serving wheel diameters ranging between 15.24 centimeters/6.0 inches and 53.34 centimeters/21 inches.

An adaptive device that permits increased wheel diameters to raise the center or tangent of the primary wheel to traverse harsher surface conditions.

An invention that extends the range of service and usages for existing two-wheel board style ride scooters to include a utility and payload carriage capacity.

The invention permits the implementation of a 20.32 centimeters/8 inches to 25.4 centimeters/10 inch pneumatic wheel to be disposed on a vertical plane to the drive actuator, affixed to utility carriage where so steered alignment varied by pivoting neck articulated while rider standing on platform expressing the advantages of force, fulcrum and suspension to support forward utility carriage payloads maneuverability.

A device that introduces larger diameter wheel to address surface contact variables at a higher angle-of-attack or tangent.

A device that permits user to raise and lower forward situated utility carriage while in active drive mode.

### BRIEF DESCRIPTION OF INVENTION

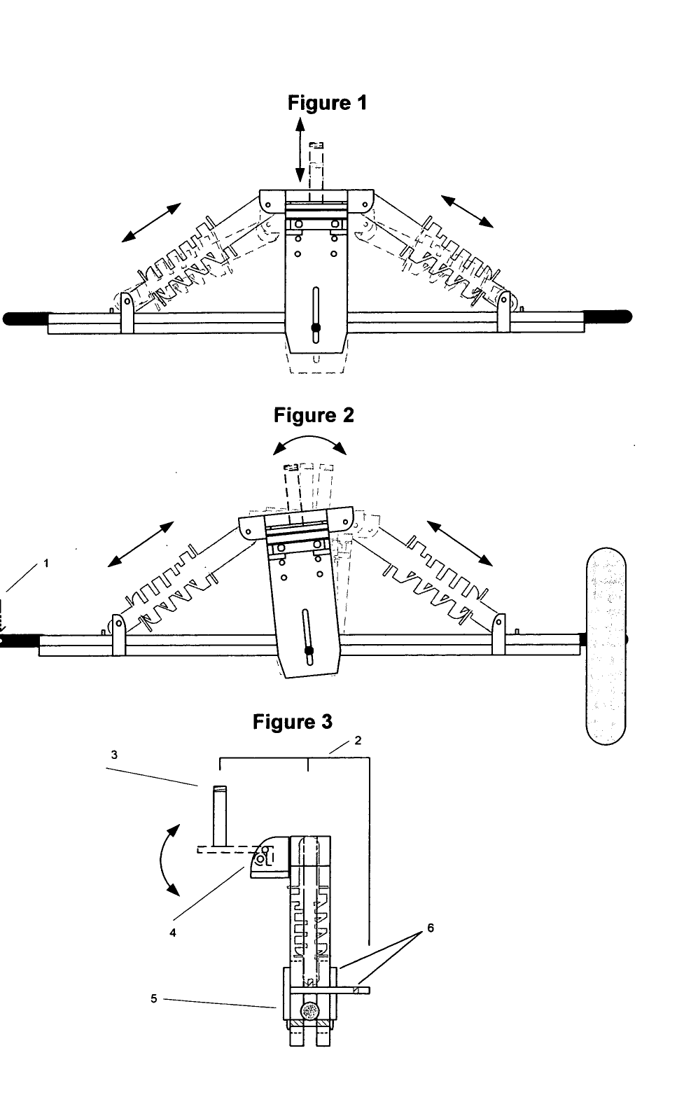

FIG. 1—Straight on view showing vertical dampening travel feature. Some figures appear with focus points.

FIG. 2—Straight on view showing horizontal dampening travel feature, focus 1 wheel keep

FIG. 3—Side view depicting fulcrum axis, pivot point, benefit end of levers

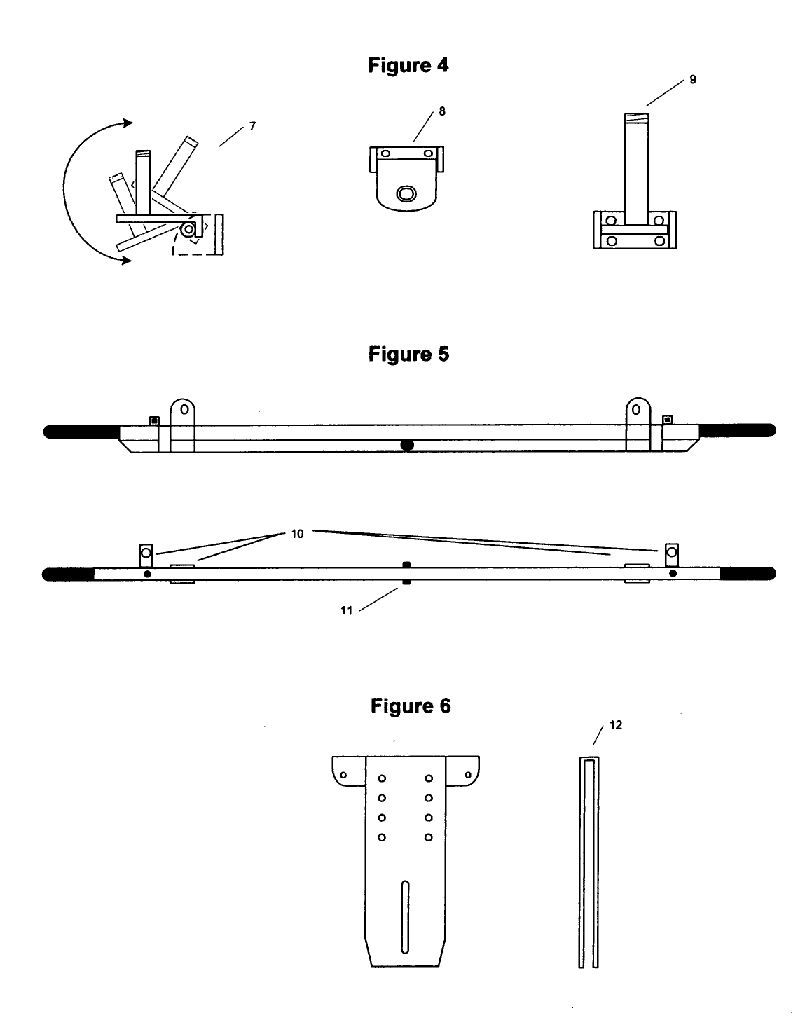

FIG. 4—Multiple views of the Neck Pivot Receiver, focus 7 depicts pivot travel

FIG. 5—Front and top view of the Load Distribution Shaft, focus 10 displays mounting points

FIG. 6—Straight on view of Interface Plate, focus 12 is a side view of Interface Plate

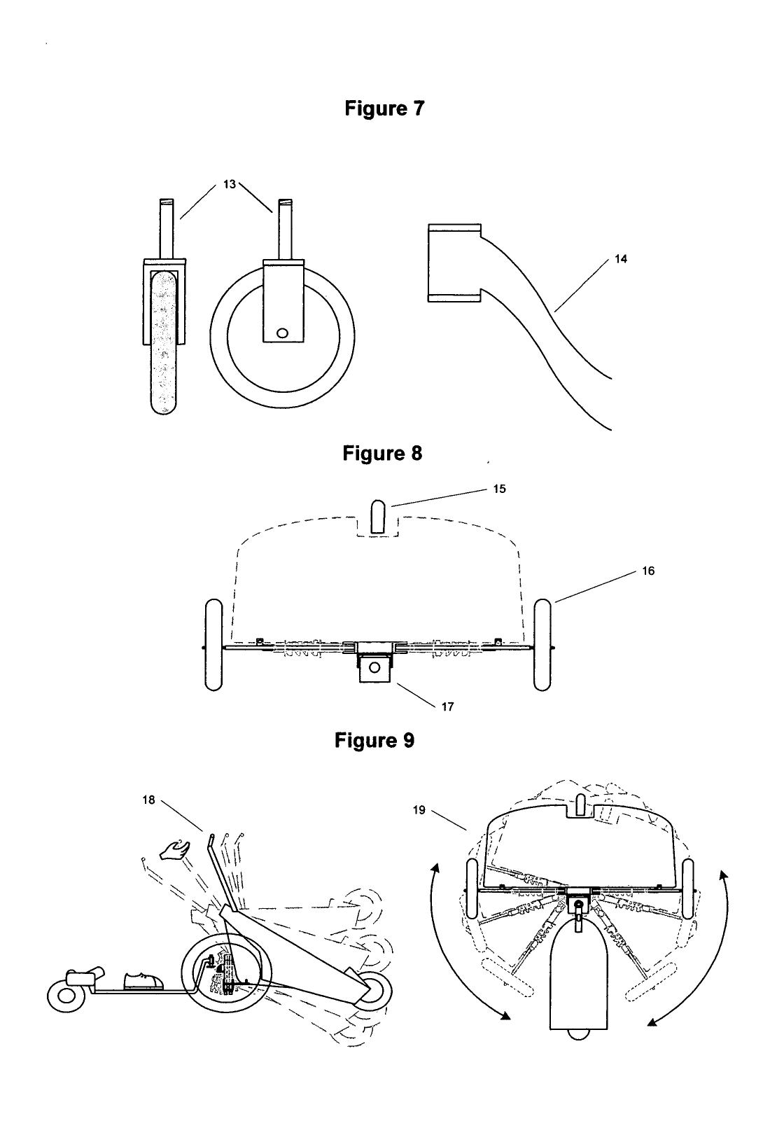

FIG. 7—Several views depicting state of the art yoke, neck and fork, focus 14 presents journal

FIG. 8—Top view showing outline of preferred utility carriage, wheel Placement

FIG. 9—Side view demonstrating range of movement, rider position and relationship to controls

### DETAILED DESCRIPTION OF INVENTION

A device that provides advantageously aligned and arranged connections and actuation points that facilitate the construction of an enhanced utility platform as referenced in FIG. 1, FIG. 2, FIG. 3 FIG. 4, FIG. 5, FIG. 6, FIG. 8 and FIG. 9, collectively.

The invention is configured to increase the wheel diameters of the primary forward support ground contacting members to 40.64 centimeters/16 inches FIG. 8, focus 16.

A device that balances weight, load and force through a center float travel aperture FIG. 5 and FIG. 6

In the particular arrangement, the invention uses a fulcrum-lever assist action to enhance load handling throughout turning radius along dual interactive axis points FIG. 3 and FIG. 9

In the arrangement of the present invention, surface impact and jarring are minimized through an Interface Plate FIG. 3 positioned centered and over a Load Distribution Shaft FIG. 5 juxtaposed by two advantageously placed dampeners that distribute suspension, load and force throughout structure. FIG. 1, FIG. 2, FIG. 3 and FIG. 9

The invention permits the implementation of one pneumatic front ground contacting member disposed on a vertical plane to the drive actuator FIG. 8 at 0 steering alignment varied by attributes articulated with rider standing on platform expressing the advantages of qualities depicted in FIG. 1, FIG. 2, FIG. 3, FIG. 8 and FIG. 9 of the invention to support forward utility carriage payloads.

Adjustability between Interface Plate FIG. 6 and Neck Pivot Receiver FIG. 4 mitigates synergistic effects of wheel diameter and Fulcrum assist action to Load Distribution Shaft FIG. 5 form a complete lever offset. FIG. 3, FIG. 8 and FIG. 9

It can readily be observed through FIG. 4 that there are matching alignment points for adjustability in relationship to Interface Plate depicted in FIG. 6. Moving the Neck Pivot Receiver FIG. 4 up and down this mounting pattern will vary fulcrum effect depicted in FIG. 9

Where force on control levers FIG. 9, focus 18 dispatching from rider standing as depicted at FIG. 9, derive a mechanical advantage inherent in the instant device.

1. A device that is situated so as to permit a bolt on solution which results in a free standing vehicle platform consisting of four ground contacting members;

2. A device that provides a mounting platform for the integration of common two wheel standing scooter, larger primary wheel diameter; and a utility carriage;

3. In the present arrangement and alignment device improves steering dynamics of two wheel standing scooters through the use of dual interactive axis points displaced through Neck Pivot Receiver acting with fulcrum-lever assist dynamics while dampeners affixed and articulating;

4. A device that facilitates an arrangement of ground contacting members in a diamond shaped pattern vertical to the longitudinal plane to enhance vehicle stability throughout steering control radius in conjunction with claim 1;

5. A device that provides a dampening platform through the expression of dampeners affixed and articulating between Interface Plate and Load Distribution Shaft;

6. In the particular arrangement, the invention uses a fulcrum-lever assist action to enhance load handling throughout dual interactive axis points;

7. Invention increases the range of wheel diameters of the primary forward support wheel to 53.34 centimeter/21 inches in keeping with claim 3;

8. In the invention an Axle-to-steering neck is dampened throughout an available dual interactive axis arrangement as revealed in claim 3;

9. The invention permits the implementation of a 20.32 centimeters/8 inch to 25.4 centimeter/10 inch pneumatic front ground contacting member disposed on a vertical plane to the drive actuator at 0 steering alignment varied by attributes found in claim 3 and claim 4 articulated by rider standing on platform expressing the advantages of the invention to support forward utility carriage payloads maneuverability;

10. A device that increases safety quotients of two wheel board type scooter as per claim 1;

11. A device that facilitates expanded utility capacity for two wheel board type scooter, as reported in claim 2.
